(19) United States
(12) Patent Application Publication
(10) Pub. No.: US 2012/0077425 A1
(43) Pub. Date: Mar. 29, 2012

(54) Accessible Hood Sash

(75) Inventors: Jeffrey Grek, Piscataway, NJ (US); Robert Eckhardt, South River, NJ (US); Richard Scott Wernoski, Hillsborough, NC (US)

(73) Assignee: UNIVERSITY OF MEDICINE AND DENTISTRY OF NEW JERSEY, Somerset, NJ (US)

(21) Appl. No.: 13/248,988

(22) Filed: Sep. 29, 2011

Related U.S. Application Data
(60) Provisional application No. 61/387,750, filed on Sep. 29, 2010.

(51) Int. Cl. B08B 15/02

(52) U.S. Cl. 454/56

(57) ABSTRACT

The present invention provides an apparatus and various embodiments thereof which allow the user of a laboratory fume hood to operate equipment and conduct experiments, while keeping the hood sash in a closed position.

### CROSS REFERENCE TO RELATED APPLICATIONS

This application claims priority to U.S. Provisional Patent Application No. 61/387,750, filed on Sep. 29, 2010, the content of which is hereby incorporated by reference in its entirety.

### STATEMENT REGARDING FEDERALLY FUNDED RESEARCH

Not Applicable.

### FIELD OF THE INVENTION

The present invention relates to the field of laboratory and safety equipment, specifically biological safety cabinets and fume hoods.

### BACKGROUND OF THE INVENTION

A chemical fume hood (or fume hood) is a ventilated cabinet used in laboratory and research settings, which protects users from dangerous chemicals but does not filter the air being circulated. A biological safety cabinet is another type of laboratory ventilation and containment device that is commonly used for microbiological research and assays. It consists of fixed back and side walls, and a front face (designated herein as a hood sash) which can be completely or partially open or closed, creating a workspace area. The cabinet is designed to limit exposure by the user to potentially hazardous biological agents through various means, including High Efficiency Particulate Arresting (HEPA) filters and specialized airflow through the system. Air may be filtered and then released into the air surrounding the cabinet, out of the building and/or funneled back into the cabinet. Additionally, many cabinets have features that also allow for the prevention of contamination from the laboratory environment.

Biological safety cabinets have three general types of designs and corresponding levels of protection. Type I cabinets employ basic protection systems and are used for common, generally harmless microorganisms. Type I biosafety cabinets protect the user from contamination by the contents of the cabinet by using a stream of inward air to confine aerosols created during experimentation. However, such cabinets fail to protect the contents of the cabinet from external environmental factors and contamination. Type II cabinets employ additional safety measures, by filtering the inflowing and exhaust air, thereby preventing contamination of the cabinet from external sources. This class is then further subdivided based on whether exhaust air is channeled back into the laboratory environment (type II A) or through a dedicated duct system to the outside (type II B). Type III cabinets provide the greatest protection by being completely sealed from the outside environment and are gastight, enabling manipulation of the internal contents only though the use of glove ports.

Class II A biosafety cabinets are enclosed spaces that have an opening in the front to allow manipulation of the internal contents of the cabinet. A continuous stream of downward flowing air travels through the cabinet and is purged to prevent cross-contamination. The air moves though the use of blowers or fans and passes through a HEPA filter. The work zone is enclosed by side and back walls with a workspace at the bottom with lighting and filters at the top. The front opening has an adjustable opening called a hood sash.

The front opening hood sash can be set to a specified height while work is being performed. The hood sash can be opened to allow for the introduction of samples and equipment to the cabinet, as well as for cleaning. The sash can be closed for added protection of the user, the samples, the atmosphere surrounding the cabinet and/or the experiment being conducted. If the hood sash is opened too wide, the inflow of air can become too weak to maintain adequate safety and prevent cross contamination. While a narrow opening of the hood sash ensures adequate air flow and safety, it also compromises the user's ability to work effectively. This makes it highly difficult to utilize some laboratory equipment, most notably microscopes, within the biosafety cabinet when the hood sash is adjusted too small or closed. Existing technologies have aimed to solve this problem but are cost prohibitive. Furthermore, existing solutions do not allow for removal or alterations to the hood sash to account for different experiments or experimental conditions, due its weight and fixed attachment to the cabinet.

### SUMMARY OF INVENTION

The present invention addresses the inability of biosafety cabinets and fume hoods to guarantee protection of the user while also allowing for reasonably unrestrained functionality in the hood. It allows the user to continue to perform activities with a microscope or other equipment, while the hood sash is in a closed or small position. The hood sash can be made from any transparent, laboratory-safe material, including, but not limited to, polycarbonate resin material and glass, which may or may not be treated to increase its resistance to heat, moisture and damage from chemical exposure, Its height and width may vary, according to the specified use or application, but the hood sash can be constructed to fit all biosafety cabinets and fume hoods, including the common, standard sizes of approximately four and six feet. The hood sash contains a cutout, of variable shape and size, located at the upper segment of the hood sash, sufficient in size to allow access and operation within the hood. For example, the cutout may be a rectangular or oval shape, of adequate size, through which the eyepieces of a microscope can pass, which also allows the microscope to be adjusted for differences in height. Additionally numerous segments of the hood sash may be capable of opening, by virtue of a cutout portion, to allow the user to manipulate the microscope or other instrumentation as well as remove or add samples. Furthermore, the cutout portions may be covered by removable patches of the hood sash material in order to maintain the ability to have an intact hood sash or alternatively, the hood sash with the cutout. The hood sash is not permanently attached to the cabinet, but is instead affixed using a temporary means of attachment, such as Velcro adhesive, magnets, metal ties, or bolts. Finally, there can be handles spaced evenly on the hood sash to facilitate the removal or the attachment of the hood sash to a cabinet, as well as one or more safety posts of the same material as the hood sash, placed in the biosafety cabinet to prevent the hood sash from falling to the floor if the temporary means of attachment become detached.

### BRIEF DESCRIPTION OF FIGURES

FIG. 1 depicts one embodiment of the present invention and its component parts, including exemplary locations for the means of attachment and a cutout section;

FIG. 2 is an illustration of another embodiment of the invention, wherein the hood sash features cutouts of various sizes and locations;

FIG. 3 represents another embodiment of the present invention, featuring a removable patch over the cutout and additional options for cutout placement and shape and means of grasping; and

FIG. 4 is a schematic representation of the invention with the dimensions indicated of the preferred embodiment, as well as the stand-out safety posts on each side of the hood.

### DETAILED DESCRIPTION OF PREFERRED EMBODIMENTS

In a first embodiment, the present invention comprises a hood sash which can be attached to the front face of a type I or type II biological safety cabinet or chemistry fume hood, comprising a sheet of transparent and durable material; one or more cutouts therein; means of attachment to the front of the cabinet frame; and means of removal from the cabinet frame. The present invention is intended to allow the performance of various laboratory and research applications and the use of various types of laboratory equipment within the safety cabinet.

In another embodiment of the invention, the hood sash can be made of glass or transparent and durable thermoplastic polymer, including, but not limited to, the thermoplastic material sold as Lexan®, with dimensions equal to the dimensions of the front opening of a standard type I or II biosafety cabinet.

In another embodiment of the present invention, the cutout section at the top center of the sheet can be of a size and shape sufficient to allow the eyepieces of a microscope to exit the front of the cabinet and therefore be available to the user to operate.

In further embodiments of the present invention, various sections of the hood sash may contain cutouts with removable covers to allow access to the cabinet in different regions and at different heights. These may be customizable to user, the nature of the work occurring in the laboratory and/or industry.

In another embodiment, the number and means of attachments can vary depending on the size of the cabinet and the dimensions of the sheet. The attachments can be made out of Velcro adhesive. In another embodiment, these attachments can also be magnets, bolts, or clips.

In a further embodiment, there may also be one or more sets of handles, or some other means to grasp the sash, positioned on the hood sash to allow for easy attachment, adjustment and removal. The handles can be made from any laboratory-safe material, including, but not limited to, plastic, metal or ceramic.

In another embodiment, the present invention comprises two posts on either side of the biosafety cabinet, made of the same material as the present invention, which provides stability in the event that the means of attaching the hood sash to the safety cabinet fails to maintain the attachment. In a preferred embodiment, these posts can be one-half inch wide, one-quarter inch thick and 10 inches high to function to stop the hood sash from falling on the equipment or arms of the user in the event of a detachment of sash from the cabinet.

### DEFINITIONS

The term “biological safety cabinet” (or “biosafety cabinet”), as used herein, refers to a ventilated cabinet which uses a variety of combinations of HEPA filtration, laminar air flow and containment to provide any or all of the following levels of protection: user protection from harmful agents inside the cabinet; product protection to avoid contamination of the work, experiment, or process; and/or environmental protection from contaminants contained within the cabinet,

The term “chemical fume hood,” as used herein, refers to a ventilated cabinet wherein neither the intake or exhaust air is HEPA filtered, which protects users from exposure to volatile chemicals.

The term “HEPA filter,” as used herein, refers to a high efficiency particulate air filter designed to remove particulates, including microorganisms and infectious agents, from the air.

The term “sash” (or “hood sash”) as used herein, refers to the movable front face of the cabinet or fume hood, usually in glass, capable of upward and downward movement, often by virtue of a counterbalance mechanism.

The term “polycarbonate sheet,” as used herein, refers to any thermoplastic polymer material with the characteristics of transparency, durability and impact and temperature resistance, including, but not limited to, Lexan® thermoplastic, other polycarbonate resin thermoplastics and other materials derived from bisphenol A and carbonyl chloride.

### EXAMPLES

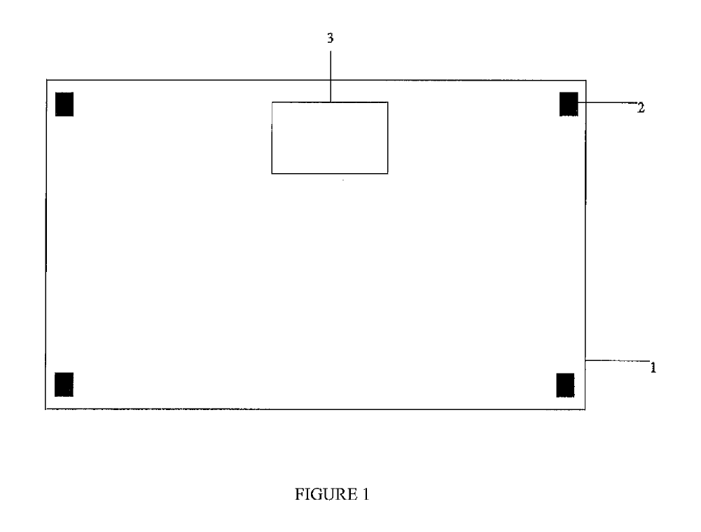

In one example of an embodiment of the present invention, the hood sash may contain only one cutout, to allow access to the contents of the biological safety cabinet or fume hood, while maintaining the integrity of the safety precautions and air flow, as shown in FIG. 1, wherein the back of the hood sash 1 is shown and is temporarily affixed to the cabinet by some means of attachment 2, including, but not limited to, Velcro, magnets, bolts or clips. A cutout may be located in the upper segment of the hood sash, the size and shape of which may vary, shown in FIG. 1 as a square cutout 3.

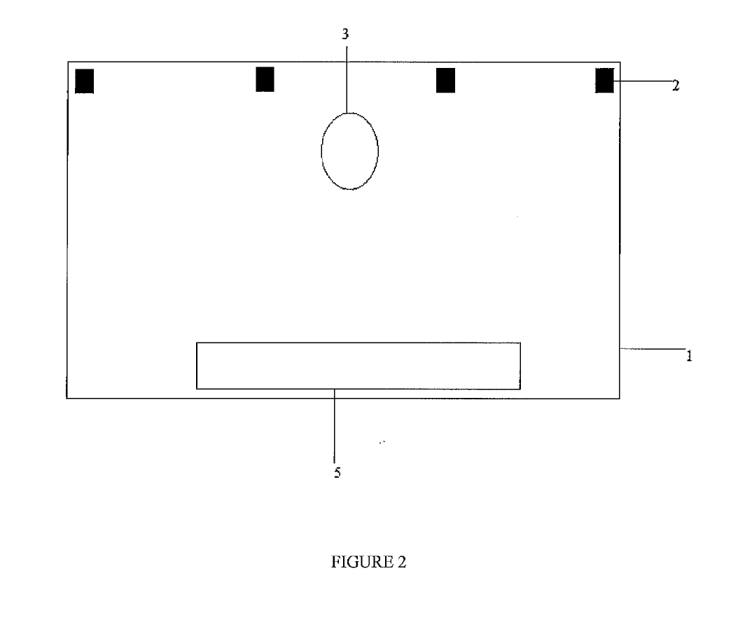

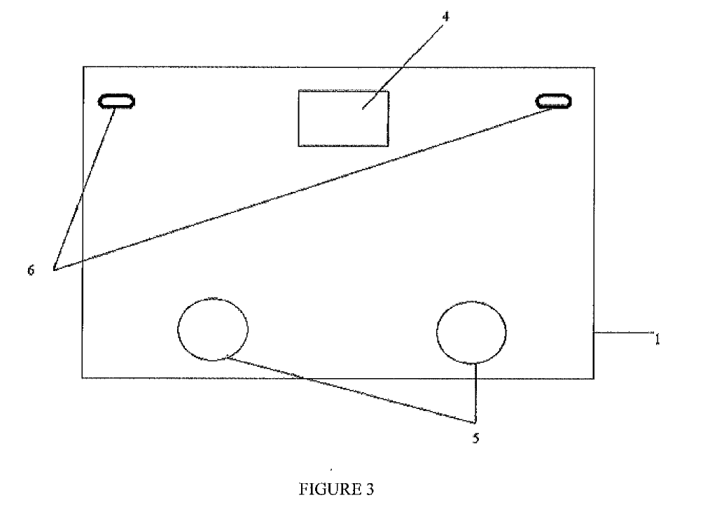

FIGS. 2 and 3 demonstrate other possible embodiments of the present invention wherein the cutouts may be found at one more regions on the hood sash; may be of various shapes and sizes; and may be covered by a removable patch, which is made of the same material as that of the hood sash. In FIG. 2, the hood sash 1 is temporarily affixed using any of the means of attachment described which are arranged in a series along the top of the hood sash 2. The cutout found in the upper segment of the hood sash is an oval shape in this FIG. 3 and there is an additional cutout in the lower segment of the hood sash which can allow additional access to the cabinet and manipulation of the contents of the cabinet 5.

FIG. 3 depicts one embodiment of the present invention, wherein the hood sash 1 is shown from the front view and the cutout is covered by the removable patch of hood sash material 4. Additional cutouts, in the shapes of circles 5 are found at the bottom to allow the user to insert hands, arms or additional instrumentation and equipment. One possible arrangement of the means of grasping 6 is depicted on the top corners of the hood sash.

In other contemplated designs of the present invention, the bottom portion of the sheet can be cut shorter than the height of the opening to allow for the arms of the user to enter into the cabinet for the manipulation of samples and instrumentation on and in the work space. At the upper segment of the sheet, a section is removed to create the cutout 3 that has the dimensions of approximately five inches wide by seven inches high to allow for the eyepieces of a microscope to exit the front of the cabinet and be available to the user to operate. The top of the sheet has a series of at least two attachments that allow for the hood sash to be affixed to the cabinet, by Velcro, magnets, bolts or clips.

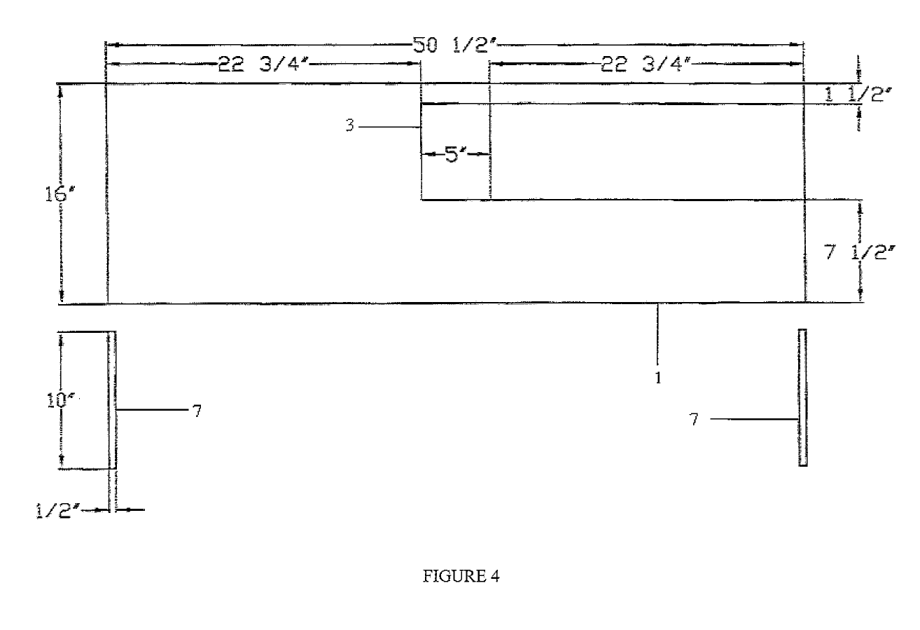

FIG. 4 illustrates the dimensions of a preferred embodiment. It further illustrates one example of the dimensions and placement of the posts 7 which can be positioned within the biosafety cabinet in the space between the bottom surface of the safety cabinet and the hood sash. These posts can be made of the same transparent, laboratory-safe material as the hood sash or any durable material. One example of appropriate dimensions for the posts, as shown in FIG. 4, is one-half inch wide, one-quarter inch thick and ten inches in height.

What is claimed is:

1. A removable hood sash comprising a transparent, laboratory-safe sheet of durable material; a cutout therein; means of attachment to the front of the cabinet frame; and means of grasping the hood sash.

2. The hood sash of claim 1 wherein the transparent, laboratory-safe sheet of durable material is selected from a group of materials comprising polycarbonate resin, bisphenol A and carbonyl chloride derivatives, and Lexan® thermoplastic, of approximately one-fourth of one inch in thickness.

3. The hood sash of claim 1 wherein the cutout may be covered by a removable patch of the material of the hood sash.

4. The hood sash of claim 1 further comprising a cutout and removable patch to cover the cutout in the lower segment of the hood sash to allow access to contents in the cabinet.

5. The hood sash of claim 1 wherein the means of attachment of the hood sash to the front frame of the biological safety cabinet comprise pieces of Velcro, magnets, bolts or clips.

6. The hood sash of claim 1 wherein the means of grasping the hood sash—to remove from and position it on the frame of the cabinet, after or between uses—comprise handles, knobs or grips, made of plastic, metal or ceramic.

7. The hood sash of claim 1 further comprising one or more safety posts which can be positioned within the safety cabinet below the hood sash in an appropriate position to stop the hood sash from falling if the hood sash were to become detached from the biosafety cabinet.

8. The hood sash according to claim 1, manufactured in sizes appropriate for use with types I and II biological safety cabinets, including the standard cabinet sizes of four and six feet.

9. A method of using the hood sash of claim 1 to facilitate laboratory procedures and research applications within the biological safety cabinet, including tissue cultures and adjustment and utilization of the eyepiece of a microscope.
